(19) United States
(12) Patent Application Publication
(10) Pub. No.: US 2025/0260105 A1
(43) Pub. Date: Aug. 14, 2025

(54) REPLACEABLE BATTERY

(71) Applicant: TOYOTA JIDOSHA KABUSHIKI KAISHA, Aichi-ken (JP)

(72) Inventors: Yutaroh GOTOH, Toyota-shi (JP); Masataka OGUSHI, Nisshin-shi, (JP); Naoki KASUYA, Kariya-shi (JP)

(73) Assignee: TOYOTA JIDOSHA KABUSHIKI KAISHA, Aichi-ken (JP)

(21) Appl. No.: 19/043,524

(22) Filed: Feb. 3, 2025

(30) Foreign Application Priority Data
Feb. 9, 2024 (JP) 2024-018931

(51) Int. Cl. H01M 50/209; H01M 50/249; H01M 50/258

(52) U.S. Cl. CPC H01M 50/209; H01M 50/249; H01M 50/258; H01M 2220/20

(57) ABSTRACT

A replaceable battery includes: a cell stack having a rectangular parallelepiped shape, in which a plurality of battery cells are stacked; a binding member for binding the cell stack; and a case for accommodating the cell stack, in which the case includes: a main body part having a rectangular tube shape and covering a side surface of the cell stack; a first lid part connected to a front end of the cell stack and configured to close an opening end at a front of the main body part having the rectangular tube shape; and a second lid part having a connector formed so as to project outwardly and be connectable to the vehicle, and connected to a rear end of the cell stack via a support rod and configured to close an opening end at a rear of the main body part having the rectangular tube shape.

### CROSS REFERENCE TO RELATED APPLICATIONS

This application is based upon and claims the benefit of priority from Japanese patent application No. 2024-018931, filed on Feb. 9, 2024, the disclosure of which is incorporated herein in its entirety by reference.

### BACKGROUND

The present disclosure relates to a replaceable battery.

Patent Literature 1 discloses a replaceable battery removably mounted on a vehicle.

Patent Literature 1: Japanese Unexamined Patent Application Publication No. 2019-169337

### SUMMARY

A replaceable battery is required to be lightweight while maintaining its high rigidity.

The present disclosure has been made in view of the above background, and it is an object of the present disclosure to provide a replaceable battery capable of realizing weight reduction while preventing deterioration in rigidity.

According to the present disclosure, a replaceable battery configured to be removably mounted on a vehicle includes at least:
a cell stack having a rectangular parallelepiped shape, in which a plurality of battery cells are stacked;
a binding member for binding the cell stack; and
a case for accommodating the cell stack bound by the binding member,
in which the case includes:
a main body part having a rectangular tube shape and covering a side surface of the cell stack;
a first lid part connected to a front end of the cell stack and configured to close an opening end at a front of the main body part having the rectangular tube shape; and
a second lid part having a connector formed so as to project outwardly and be connectable to the vehicle, and connected to a rear end of the cell stack via a support rod and configured to close an opening end at a rear of the main body part having the rectangular tube shape.

In the replaceable battery, the front end of the cell stack is connected to the first lid part, and rear end of cell stack is connected to the second lid part via the support rod. Thus, when a worker lifts replaceable battery, the load on the main body part of the case is reduced. Therefore, replaceable battery can reduce the thickness of the main body part of the case in which the load is reduced to reduce the weight. That is, replaceable battery can reduce the weight while preventing the deterioration of rigidity.

According to the present disclosure, it is possible to provide a replaceable battery capable of realizing weight reduction while preventing deterioration in rigidity of the replaceable battery.

The above and other objects, features and advantages of the present disclosure will become more fully understood from the detailed description given hereinbelow and the accompanying drawings.

### BRIEF DESCRIPTION OF DRAWINGS

FIG. 1 is a schematic perspective view showing an external view of a replaceable battery according to a first embodiment;

FIG. 2 is an enlarged schematic perspective view of the periphery of a front case provided at the front end of the replaceable battery according to the first embodiment;

FIG. 3 is an enlarged schematic perspective view of the periphery of a rear case provided at the rear end of the replaceable battery according to the first embodiment;

FIG. 4 is a flowchart showing a flow of assembly of the replaceable battery according to the first embodiment;

FIG. 5 is a schematic perspective view for explaining the flow of assembly of the replaceable battery according to the first embodiment;

FIG. 6 is a schematic perspective view for explaining the flow of assembly of the replaceable battery according to the first embodiment;

FIG. 7 is a schematic cross-sectional diagram of a YZ plane of the replaceable battery according to the first embodiment; and

FIG. 8 is a schematic cross-sectional view of a ZX plane of the replaceable battery according to the first embodiment.

### DESCRIPTION OF EMBODIMENTS

The present disclosure will be described hereinafter through embodiments of the present disclosure. However, the disclosure according to the claims is not limited to the following embodiments. Further, not all of the components/structures described in the embodiments are necessarily essential as means for solving the problem. For the clarification of the description, the following descriptions and the drawings are partially omitted and simplified as appropriate. The same elements are denoted by the same reference numerals or symbols throughout the drawings, and redundant descriptions are omitted, as necessary.

### First Embodiment

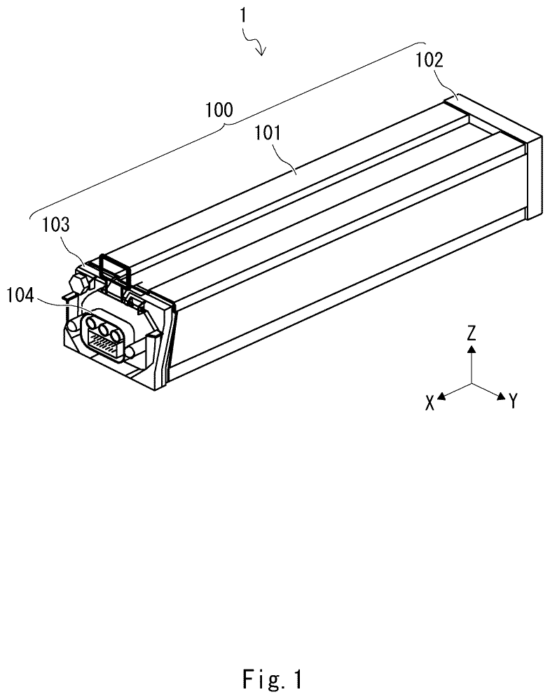

FIG. 1 is a schematic perspective view showing an external view of a replaceable battery 1 according to a first embodiment. The replaceable battery 1 is also referred to as a battery pack, a battery module, or the like, and is removably mounted on a vehicle such as a battery electric vehicle (BEV) driven by a motor using electricity as a power source. The replaceable battery 1 is reduced in size and weight so that, for example, a worker (including a work robot and the like) can easily insert and remove the replaceable battery 1 into and from a battery electric vehicle (BEV). The worker includes a work robot.

As shown in FIG. 1, in the replaceable battery 1, the outer shape of a rectangular parallelepiped shape is defined by a case 100 for accommodating a cell stack and the like. The case 100 includes a case main body (a main body part) 101 having a rectangular tube shape, a front case 102 serving as a lid part for closing one opening end of the case main body 101 (an opening part of the case main body 101 at the front end thereof), and a rear case 103 serving as a lid part for closing the other opening end of the case main body 101 (an opening part of the case main body 101 at the rear end thereof). Further, a connector 104 formed so that it protrudes outward so as to be connectable to a connector on the vehicle side is provided in the rear case 103 that is provided at the rear end of the replaceable battery 1. For example, a worker accommodates the replaceable battery 1 in the storage space of the vehicle while sliding the replaceable battery 1 in the longitudinal direction (the X-axis direction), whereby the connector 104 of the replaceable battery 1 is connected to the connector on the vehicle side.

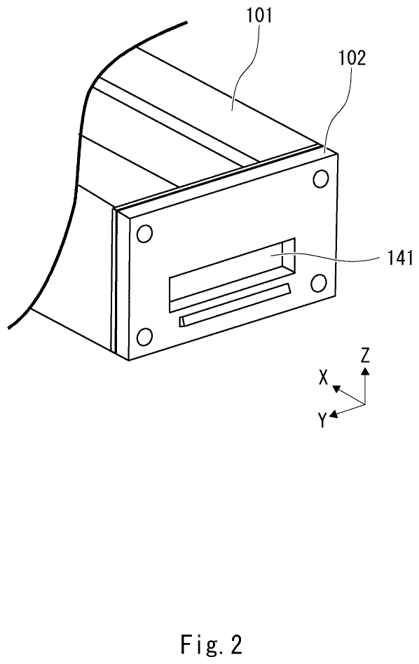

FIG. 2 is an enlarged schematic perspective view of the periphery of the front case 102 provided at the front end of the replaceable battery 1. As shown in FIG. 2, a pull-handle 141 for sliding the replaceable battery 1 is provided at the front case 102. The worker can slide the replaceable battery 1 by holding the pull-handle 141 and then pushing or pulling the replaceable battery 1.

Further, the replaceable battery 1 can be placed on, for example, a carriage and then conveyed. When the replaceable battery 1 is taken out of the carriage so as to be accommodated in the storage space, the height of the carriage is adjusted to that of the storage space and the pull-handle 141, so that the replaceable battery 1 is accommodated in (i.e., slid into) the storage space. On the other hand, when taking the replaceable battery 1 out of the storage space and placing it on the carriage, the height of the carriage is adjusted to that of the storage space and the replaceable battery 1 is taken out of the storage space by pulling the pull-handle 141.

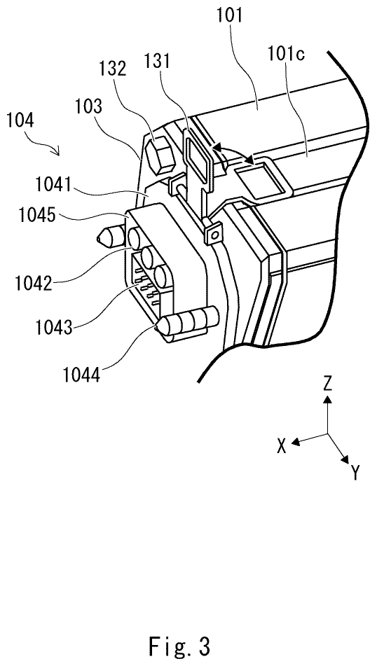

FIG. 3 is an enlarged schematic perspective view of the periphery of the rear case 103 provided at the rear end of the replaceable battery 1. As shown in FIG. 3, in addition to the connector 104, a grip-handle 131 and a relief valve 132 are provided in the rear case 103.

The connector 104 includes a base 1041, a high-voltage terminal 1042, a low-voltage terminal 1043, a pin 1044 for alignment, and a cover 1045 made of metal. The base 1041 is disposed on the main surface of the rear case 103. All of the high-voltage terminal 1042, the low-voltage terminal 1043, and the pin 1044 for alignment are formed so that they protrude outward from main surface of the base 1041. The cover 1045 is formed so that it surrounds the side surfaces of the high-voltage terminal 1042 and the low-voltage terminal 1043. The high-voltage terminal 1042 is a terminal for transmitting electricity output from a cell stack accommodated in the case 100 of the replaceable battery 1 to a vehicle on which the replaceable battery 1 is mounted. The low-voltage terminal 1043 is a terminal for transmitting a control signal from a vehicle to the replaceable battery 1, and for transmitting a signal indicative of a result of monitoring of a cell stack (a result of a voltage measurement etc.) from the replaceable battery 1 to a vehicle.

The relief valve 132 discharges gas generated in the cell stack accommodated in the case 100 of the replaceable battery 1. Here, even when gas is discharged from the relief valve 132, the high-voltage terminal 1042 and the low-voltage terminal 1043 can be protected by the cover 1045 made of metal.

Although not shown, in a wall surface that faces the rear case 103 in the storage space of the vehicle in which the replaceable battery 1 is accommodated, an exhaust port through which gas discharged through the relief valve 132 is discharged to the outside via the vehicle is provided. The gas discharged from the relief valve 132 of the replaceable battery 1 is discharged, for example, from the lower side of the vehicle to the outside of the vehicle through a duct connected to the exhaust port. Therefore, even if gas is discharged from the relief valve 132 in a state in which the replaceable battery 1 is accommodated in the storage space of the vehicle, the gas does not flow to an area where a worker is present, and thus the safety of the worker can be ensured.

The grip-handle 131 is provided so at to be rotatable around a shaft extended along an upper edge of the rear case 103 and is placed on an upper surface of the case main body 101 when not in use. Therefore, by holding the grip-handle 131, the replaceable battery 1 can be carried in such a way that the rear end thereof is suspended without interfering with the connection of the connector 104.

More specifically, when carrying the replaceable battery 1, the worker holds the rotatable grip-handle 131 with one hand to lift the replaceable battery 1 and holds the pull-handle 141 with the other hand to support the replaceable battery 1. Thus, the worker can carry the replaceable battery 1 while stabilizing the center of gravity (keeping balance).

Here, on the upper surface of the case main body 101, a rib groove 101c is formed along longitudinal direction (X-axis direction) of the case main body 101. Therefore, the grip-handle 131 is accommodated in the rib groove 101c when not in use. Thus, a worker can easily accommodate the replaceable battery 1 in the storage space of a vehicle. Further, the strength of the upper surface of the case main body 101 is improved as well by forming the rib groove 101c on the upper surface thereof.

Note that it is preferable to reduce the thickness of the case main body 101, and to make the thickness of the rear case 103 larger than the thickness of the case main body 101. By reducing the thickness of the case main body 101, the case 100 is reduced in weight, and by providing the grip-handle 131 on the thicker the rear case 103, the deformation of the case 100 is suppressed. For example, a die-cast member is used as the rear case 103. By this configuration, the rigidity of the rear case 103 on which the grip-handle 131 is provided is improved, and workability when the grip-handle 131 is used is also improved. In addition, by reducing the thickness of the case main body 101, even when gas is generated in the cell stack 110, the case main body 101 is elastically deformed and swells outward, thereby suppressing a rapid increase in the internal pressure of the case.

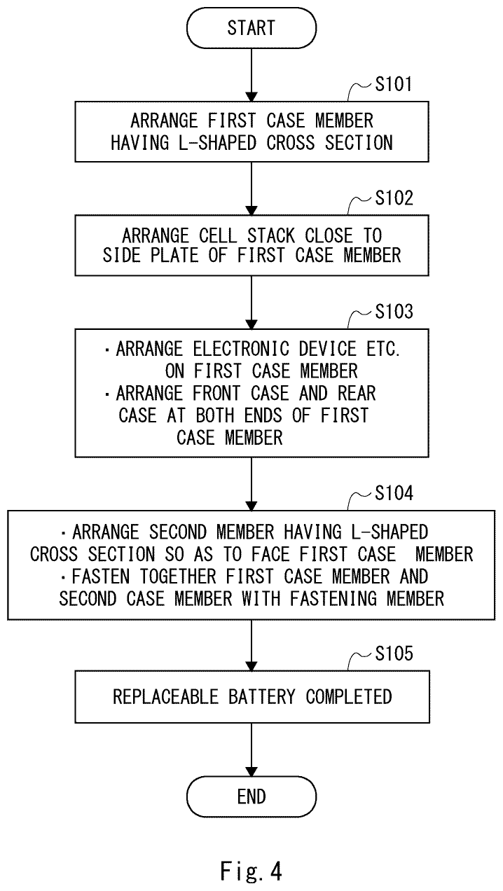

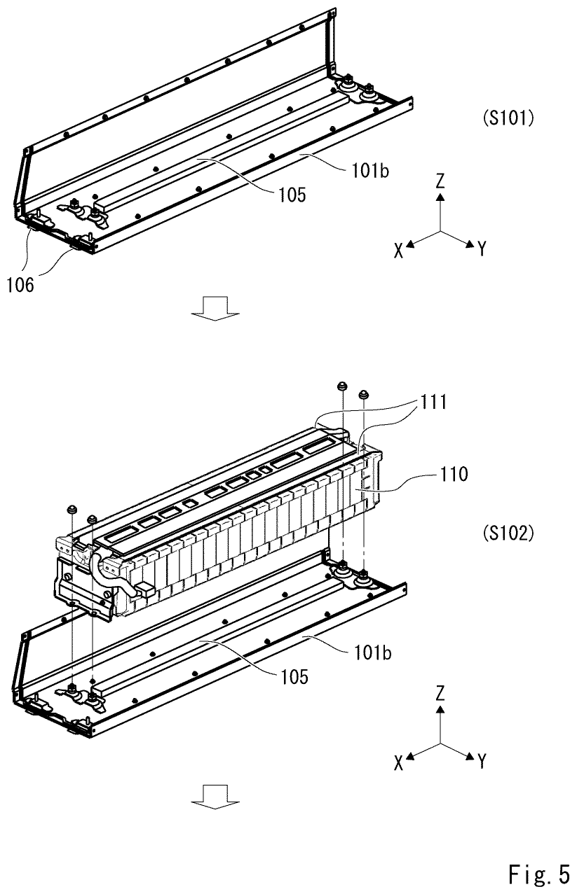

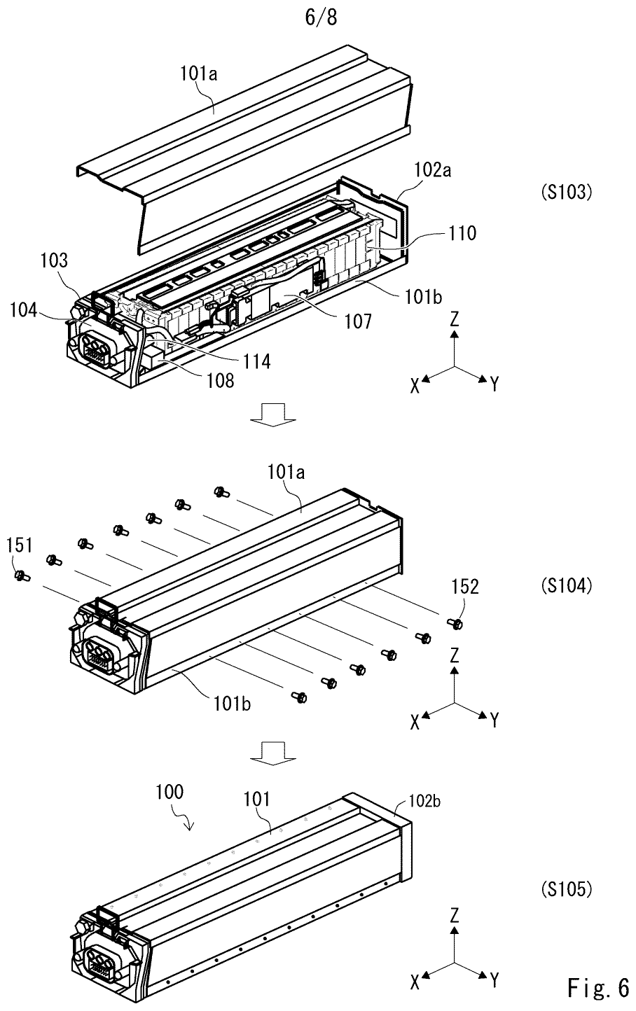

Next, with reference to FIGS. 4 to 6, an object to be accommodated in the case 100 of the replaceable battery 1 will be described, and the flow of assembling the replaceable battery 1 will be described. FIG. 4 is a flowchart showing the flow of assembling the replaceable battery 1. FIGS. 5 and 6 are schematic perspective views for explaining the flow of assembly of the replaceable battery 1. The display contents of Steps S101 to S105 shown in FIGS. 5 and 6 correspond to the results of the processes of Steps S101 to S105 in FIG. 4, respectively.

First, a lower case 101b forming the bottom plate and one side plate of the case main body 101 are disposed (Step S101). The lower case 101b is formed so that the YZ cross section thereof has an L-shape and so that it extends along the X-axis direction. A pair of rails 106 extending along the longitudinal direction (the X-axis direction) of the lower case 101b are disposed to the lower side of the bottom plate of the lower case 101b. This facilitates sliding of the replaceable battery 1 along the guide. On an upper side of the bottom plate, a metal member 105 is provided along the longitudinal direction of the lower case 101b. The metal member 105 is made of, for example, aluminum or an alloy containing aluminum (i.e., an aluminum-based metal).

Thereafter, the cell stack 110 having a rectangular parallelepiped shape is arranged at the upper side of the bottom plate of the lower case 101b close to the side plate of the lower case 101b (Step S102). The cell stack 110 is formed by stacking a plurality of battery cells into a rectangular parallelepiped shape, the plurality of battery cells being bound together with a binding member 111 such as binding band. Here, the metal member 105 provided at an upper side of the bottom plate formed by the lower case 101b and at the lower side of the cell stack 110 serves to release heat of the cell stack 110 to the outside of the case 100.

Thereafter, electronic devices such as a junction box 108 including a relay and the like and a battery monitoring apparatus 107 are further arranged on the upper side of the bottom plate of the lower case 101b (Step S103). The battery monitoring apparatus 107 includes a voltage measurement apparatus for measuring the voltage of the cell stack 110 and the voltage of each battery cell configuring the cell stack. The battery monitoring apparatus 107 is arranged in a spatial area to be described later formed between the cell stack 110 and the other side plate of the case main body 101 of an area at the upper side of the bottom plate defined by the lower case 101b. This spatial area is formed by arranging the cell stack 110 close to one side plate of the case main body 101. The junction box 108 is arranged in the spatial area between the rear end of the cell stack 110 and the rear case 103 to be described later.

An inner-side case 102a of the front case 102 is disposed at the front end of the lower case 101b (the case main body 101) (Step S103). The rear case 103 including the connector 104 is disposed at the rear end of the lower case 101b (the case main body 101) (Step S103). The rear end of the cell stack 110 and the rear case 103 are connected via a support rod 114. Thus, the junction box 108 is arranged in the spatial area between the rear end of the cell stack 110 and the rear case 103. Further, since the front end of the cell stack 110 is connected to the front case 102 having the pull-handle 141, and the rear end of the cell stack 110 is connected to the rear case 103 having the grip-handle 131 via a support rod 114, a load on the case main body 101 is reduced when an worker holds the pull-handle 141 or the grip-handle 131 and lifts the replaceable battery 1.

The support rod 114 is formed of a high-rigidity member such as steel, for example. The support rod 114 may be formed integrally with the rear case 103 by die casting or the like. This increases the strength of the connecting part between the support rod 114 and the rear case 103.

In the present embodiment, the description is given by way of example, of a case where the support rod 114 for connecting the rear end of the cell stack 110 and the rear case 103 is provided therebetween, but it is not limited thereto and another support rod for connecting the front end of the cell stack 110 and the front case 102 may be further provided. In this case, it is preferable that the two support rods overlap when viewed in a stacking direction (x-axis direction) of the plurality of battery cells. As a result, the stability when the replaceable battery 1 is lifted is improved.

Thereafter, the upper case 101a forming the top plate and the other side plate of the case main body 101 are arranged so as to face the lower case 101b (Step S104). The upper case 101a is formed so that the YZ cross section thereof is L-shaped and extends along the X-axis direction. The upper case 101a and the lower case 101b form the case main body 101 having a rectangular tube. A spatial area 160 is provided above the cell stack 110 in an internal area of the case main body 101. The spatial area 160 is also used as a smoke exhaust area for releasing gas generated in the cell stack 110. For example, gas generated in the cell stack 110 is discharged from the spatial area 160 to the outside of the case 100 via the relief valve 132.

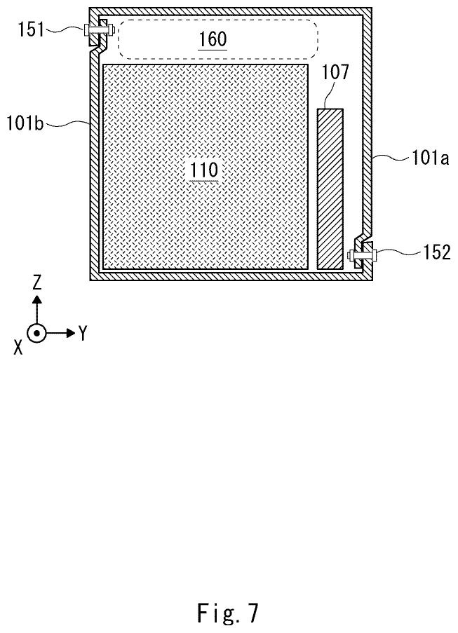

The upper case 101a and the lower case 101b are fastened by fastening members 151,152 (Step S104). FIG. 7 is a schematic cross-sectional view of the YZ plane of the replaceable battery 1. As shown in FIG. 7, an end of one side plate formed by the lower case 101b that protrudes from the spatial area 160 is fastened to an end of the top plate formed by the upper case 101a by the fastening member 151. Further, an end of the other side plate formed by the upper case 101a is fastened to an end of the bottom plate formed by the lower case 101b by the fastening member 152. By the above configuration, the cell stack 110 can be arranged close to one side plate formed by the lower case 101b without being subject to interference of the fastening member 151. As a result, for example, a spatial area sufficiently large enough for the battery monitoring apparatus 107 to be disposed therein can be secured between the cell stack 110 and the other side plate formed by the upper case 101a.

Then, an outer-side case 102b of the front case 102 is disposed at the front end of the case main body 101. In this way, the replaceable battery 1 is completed (Step S105). The outer-side case 102b has a cap-like shape, and is attached to the front end of the case main body 101 so that it covers the opening part (the opening end) of the case main body 101 at the front end thereof together with the side surfaces of the case main body 101. By this configuration, it is possible to, before gas is discharged through the relief valve 132, reduce the number of occurrences of leakage of the gas from the side of the front case 102 where a worker is working.

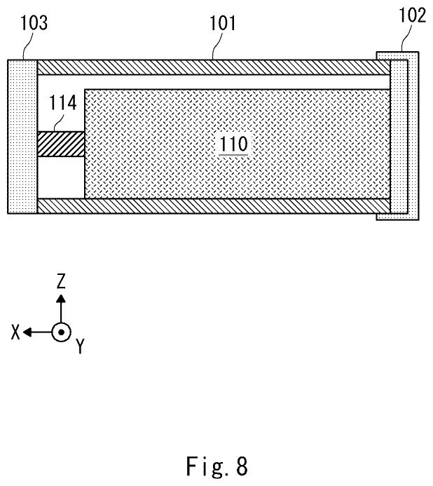

FIG. 8 is a schematic cross-sectional view of the ZX surface of the replaceable battery 1. As shown in FIG. 8, in the replaceable battery 1, the front end of the cell stack 110 is connected to the front case 102 having the pull-handle 141, and the rear end of the cell stack 110 is connected to the rear case 103 having the grip-handle 131 through the support rod 114. This reduces the load on the case main body 101 when the worker holds the pull-handle 141 and the grip-handle 131 and lifts the replaceable battery 1.

Thus, in the replaceable battery 1 according to the present disclosure, the front end of the cell stack 110 and the front case 102 having the pull-handle 141 are connected, and the rear end of the cell stack 110 and the rear case 103 having the grip-handle 131 are connected through the support rod 114. Thus, when a worker holds the pull-handle 141 and the grip-handle 131 and lifts the replaceable battery 1, the load on the case main body 101 is reduced. Therefore, the replaceable battery 1 can reduce the thickness of the case main body 101 with the reduced load, thereby reducing the weight. That is, the replaceable battery 1 can realize weight reduction while preventing deterioration in rigidity of the replaceable battery.

In the replaceable battery 1 according to the present disclosure, a heavy cell stack is arranged to one side in the case. Therefore, the worker is apt to lose balance when carrying the replaceable battery 1 due to the deviation of the center of gravity of the replaceable battery 1. On the other hand, in the replaceable battery 1 according to the present disclosure, as described above, the replaceable battery 1 can be lifted by holding the rotatable the grip-handle 131 and carrying the replaceable battery in such a way that the rear end thereof is suspended. More specifically, when carrying the replaceable battery 1, the worker holds the rotatable the grip-handle 131 with one hand to lift the replaceable battery 1 and holds the pull-handle 141 with the other hand to support the replaceable battery 1. Thus, the worker can carry the replaceable battery 1 while stabilizing the center of gravity (keeping balance).

In the replaceable battery according to the present disclosure, since the case main body is composed of a pair of members having an L-shaped cross section, it is easy to accommodate an object to be accommodated such as a cell stack in a case upon assembly of the cell stack. That is, the replaceable battery according to the present disclosure improves workability during assembly.

From the disclosure thus described, it will be obvious that the embodiments of the disclosure may be varied in many ways. Such variations are not to be regarded as a departure from the spirit and scope of the disclosure, and all such modifications as would be obvious to one skilled in the art are intended for inclusion within the scope of the following claims.

What is claimed is:

1. A replaceable battery configured to be removably mounted on a vehicle, comprising at least:
a cell stack having a rectangular parallelepiped shape, in which a plurality of battery cells are stacked;
a binding member for binding the cell stack; and
a case for accommodating the cell stack bound by the binding member,
wherein the case comprises:
a main body part having a rectangular tube shape and covering a side surface of the cell stack;
a first lid part connected to a front end of the cell stack and configured to close an opening end at a front of the main body part having the rectangular tube shape; and
a second lid part having a connector formed so as to project outwardly and be connectable to the vehicle, and connected to a rear end of the cell stack via a support rod and configured to close an opening end at a rear of the main body part having the rectangular tube shape.

2. The replaceable battery according to claim 1, wherein the binding member comprises:
a strip-shaped member extending along a stacking direction of the plurality of the battery cells;
a grip part provided at both end parts of the strip-shaped member for gripping the cell stack at both ends thereof.

3. The replaceable battery according to claim 1, further comprising a relay provided between the connector and the cell stack,
wherein the relay is disposed in a spatial area between the second lid part and the rear end of the cell stack.

4. The replaceable battery according to claim 1, wherein
the battery is mounted on and removed from the vehicle by being slid in a longitudinal direction,
the first lid part includes a pull-handle, and
the second lid part includes a grip-handle.

5. The replaceable battery according to claim 4, wherein
a rib groove is extended on an upper surface of the main body part in a longitudinal direction of the main body part, and
the grip-handle is accommodated in the rib groove when not in use.
